(19) United States
(12) Patent Application Publication
(10) Pub. No.: US 2010/0101924 A1
(43) Pub. Date: Apr. 29, 2010

(54) SWITCHING DEVICE

(75) Inventors: Yun Wu, Oakdale Gardens, NY (US); Alfred J. Lombardi, Syosset, NY (US); Cheng-Lung Chou, Great Neck, NY (US); Azer Ilkhanov, Brooklyn, NY (US)

Correspondence Address: Leviton Manufacturing Company Incorporated (CDFS);c/o Carter, DeLuca, Farrell & Schmidt, LLP, 445 Broad Hollow Rd. Ste. 420, Melville, NY, 11747, US

(73) Assignee: LEVITON MANUFACTURING CO., INC., Melville, NY (US)

(21) Appl. No.: 12/637,425

(22) Filed: Dec. 14, 2009

Related U.S. Application Data
(63) Continuation-in-part of application No. 12/169,233, filed on Jul. 8, 2008.
(60) Provisional application No. 60/961,188, filed on Jul. 18, 2007.

(51) Int. Cl. H01H 3/00

(52) U.S. Cl. 200/339

(57) ABSTRACT

A switching device includes a housing and a paddle actuator operably coupled to a front face of the housing and adapted to control a state of a load. The paddle actuator has a pair of opposing long sides and short sides and is configured to pivot about a hinge disposed proximate to one of the short sides of the paddle actuator. At least one component is disposed adjacent to the short side of the paddle actuator that is disposed proximate to the hinge and is configured to sense at least one condition. A control element is configured to control at least one of a sensing range and a sensitivity of the at least one component. The paddle actuator occupies at least 50% of the front face of the housing and the at least one component substantially occupies the remainder of the front face.

### CROSS REFERENCE TO RELATED APPLICATIONS

This application is a continuation-in-part of U.S. Patent Application entitled “DIMMER SWITCH” filed in the United States Patent and Trademark Office on Jul. 8, 2008 and assigned Ser. No. 12/169,233, which claims priority to Provisional Patent Application entitled “DIMMER SWITCH” filed in the United States Patent and Trademark Office on Jul. 18, 2007 and assigned Ser. No. 60/961,188, the entire contents of all of which being incorporated by reference herein.

### BACKGROUND

1. Technical Field

The present invention relates to a switching device used to control electrical systems and/or devices and, more particularly, relates to a switch for selectively adjusting or varying a state of a current load.

2. Description of Related Art

Switches and controls for electrical systems and devices have been developed that control more than one state of an electrical load or device. While it is now commonplace for devices to control a plurality of states, such as the ON/OFF/DIM/BRIGHT state of a lighting load, the integration of multiple control features in a single device typically requires more complicated manufacturing processes to accommodate the different features.

The present disclosure relates to an integrated control device that is simple to manufacture and less expensive to produce.

### SUMMARY

According to an embodiment of the present disclosure, a switching device includes a housing adapted to be mounted within a single gang electrical box and a paddle actuator operably coupled to a front face of the housing and adapted to control a state of a load. The paddle actuator has a pair of opposing long sides and a pair of opposing short sides. The paddle actuator is biased to a neutral position and is configured to pivot relative to the front face of the housing about a hinge disposed proximate to one of the short sides of the paddle actuator. At least one component is operably coupled to the housing and is disposed adjacent to the short side of the paddle actuator that is disposed proximate to the hinge. The at least one component is configured to sense at least one condition and cause the switching device to control the state of the load based on the at least one sensed condition. A control element is operably coupled to the at least one component and is configured to control at least one of a sensing range and a sensitivity of the at least one component. The paddle actuator occupies at least 50% of the front face of the housing and the at least one component substantially occupies a remainder of the front face.

According to another embodiment of the present disclosure, a switching device includes a paddle actuator adapted to control a first state of a load and having a pair of opposing long sides and a pair of opposing short sides. The paddle actuator is operably coupled to a housing adapted to be mounted within a single gang electrical box. A rocker actuator is operably coupled to the housing and is disposed at least partially within an aperture that is at least partially defined by the paddle actuator. The rocker actuator is configured to control a second state of the load. The switching device also includes at least one component configured to sense at least one condition. The at least one component is operably coupled to the housing and is disposed adjacent the paddle actuator. The at least one component is configured to cause the switching device to control at least one of the first and second states of the load based on the at least one sensed condition. The switching device also includes a wallplate mountable to the housing. The wallplate defines an aperture that surrounds the paddle actuator and the at least one component when the wallplate is mounted to the housing such that the paddle actuator and the at least one component are exposed relative to the wallplate.

According to another embodiment of the present disclosure, a switching device includes a paddle actuator adapted to control a first state of a load. The paddle actuator has a pair of opposing long sides and a pair of opposing short sides. The paddle actuator is operably coupled to a housing adapted to be mounted within a single gang electrical box. A rocker actuator is operably coupled to the housing and is disposed at least partially within an aperture defined at least partially by the paddle actuator. The rocker actuator is configured to control a second state of the load. The switching device also includes at least one sensor configured to sense at least one condition. The at least one sensor is operably coupled to the housing and is disposed adjacent the paddle actuator. The at least one sensed condition is selected from the group consisting of motion, occupancy, humidity, infrared light, ambient light, heat, barometric pressure, ultrasonic conditions, sound, imagery, and temperature. The at least one sensor is configured to cause the switching device to control at least one of the first and second states of the load based on the at least one sensed condition.

### BRIEF DESCRIPTION OF THE DRAWINGS

Various embodiments of the presently disclosed switching device are described herein with reference to the drawings wherein:

FIG. 1 is a perspective view of a switching device in accordance with the present disclosure having paddle actuator which incorporates a rocker-like intensity control disposed therein;

FIG. 2 is a perspective view of a housing for mechanically supporting the paddle actuator of FIG. 1;

FIG. 3 is a partial cross sectional view of an actuating assembly operatively associated with the switching device of FIG. 1;

FIG. 4 is a perspective view of an actuator of the actuating assembly of FIG. 3;

FIG. 5 is a top view showing a circuit board operatively coupled to the actuating assembly and the switching device of the present disclosure;

FIG. 6 is a partial cross sectional view showing the relative movement of a power/disengagement switch for use with the switching device of the present disclosure;

FIG. 7 is a partial cross sectional view showing the relative movement of a micro-switch in accordance with the present disclosure;

FIGS. 8 and 9 are side views showing the relative movement of the power switch relative to the housing;

FIGS. 10 and 11 are perspective views of a switching device in accordance with embodiments of the present disclosure;

FIG. 12 is a perspective view of an actuator operatively associated with the switching device of FIG. 11;

FIG. 13 is a top view showing a circuit board operatively coupled to the switching device of FIG. 11; and

FIG. 14 is a perspective view of a switching device in accordance with one embodiment of the present disclosure.

### DETAILED DESCRIPTION

Particular embodiments of the present disclosure are described hereinbelow with reference to the accompanying drawings wherein like reference numerals identify similar or identical elements. In the following description, well-known functions or constructions are not described in detail to avoid obscuring the present disclosure in unnecessary detail.

The switching device described herein in accordance with the present disclosure relates to a dimmer-like switch characterized by a large paddle actuator having an intensity actuator embedded therein. The paddle actuator is preferably substantially rectangular in shape having a pair of opposing long sides and top and bottom short sides. The paddle actuator is biased to a rest or neutral position by a one or more springs (e.g., leaf springs) formed in a sub-panel below the paddle. A user may press the paddle to overcome the bias and cause the paddle to rotate about one or more pivots to a depressed position wherein an ON/OFF switch is actuated. When released, the paddle returns to a biased rest position. Thus, the ON/OFF switch is actuated only momentarily. In this way, the paddle has a depressed position and a rest position rather than alternating between an “ON” position and an “OFF” position common to most household switches.

As mentioned above, an intensity actuator is disposed on a surface of the paddle actuator and is configured to rock about one or more additional pivots. The intensity actuator is biased to a rest position by one or more springs formed in the sub-panel. Springs are configured to bias the intensity actuator in a neutral, generally central position. A user may press the intensity actuator to overcome the bias of either leaf spring to adjust (decrease or increase) intensity (e.g., an INTENSITY state) as desired. More specifically, this action may be configured to change the state of a load connected to the switching device from DIM to BRIGHT and/or any one or more levels therebetween (e.g., greater than DIM and less than BRIGHT). When the intensity actuator is released, it returns to the neutral position.

The intensity actuator is located within an opening defined in the paddle actuator and is configured to operate independently of the paddle actuator. In embodiments, the opening is defined horizontally relative to the paddle actuator. That is, the opening is defined parallel to the top and bottom short sides of the paddle actuator. Further, opening may be defined close to the top short side of the paddle actuator or, alternatively, close to the bottom short side of the paddle actuator.

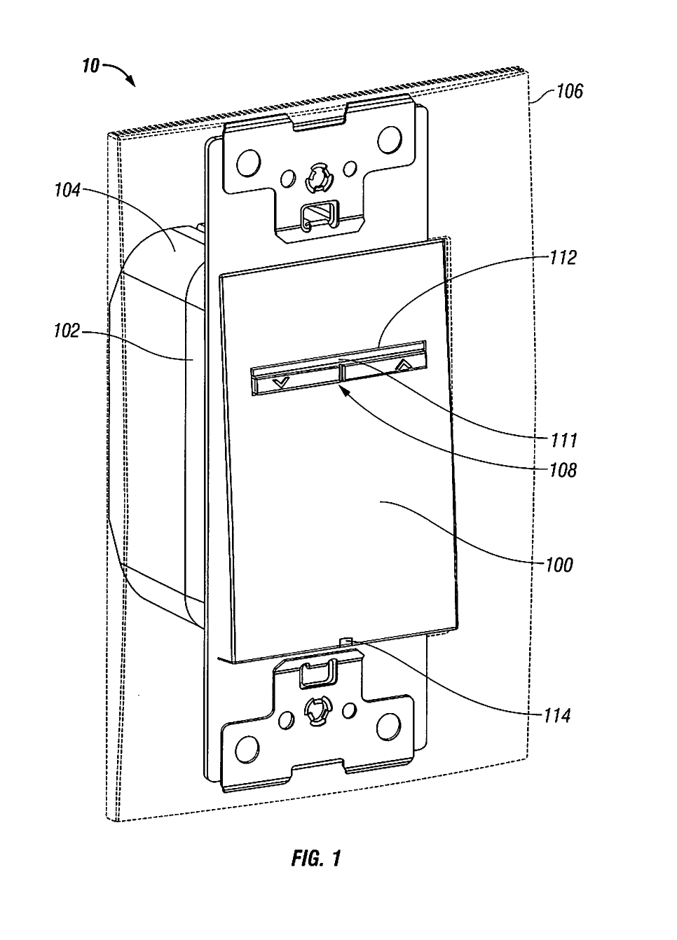

Referring now to FIGS. 1, 2, and 4, depicted therein is a switching device generally identified as reference numeral 10 which includes a housing 104, a housing cover 102, and a paddle actuator 100. The paddle actuator 100 includes an opening or aperture 112 defined therethrough which is dimensioned to receive a light pipe 111 and a rocker switch 108 therein. The paddles actuator 100 includes a series of mechanical interfaces 110A, 110B and 110C which matingly engage a corresponding number of mechanical interfaces (slots 144, 146 and 148) to maintain the paddle actuator 100 in pivotable relationship with the housing 104. A paddle actuating tab 113 (described in more detail below) includes locking elements 113C which mechanically interface with a corresponding slot 125 defined within the housing cover 102. The paddle actuator may optionally also include a light 114 (light emitting diode (“LED”)) embodied therein and configured to provide a visual status of the switching device. Alternatively, more than one light 114 can be provided which turn on and off sequentially upon pressing rocker switch 108. The paddle actuator 100 is configured to be installed in conjunction with a faceplate 106 adapted to mechanically engage the housing 104 which, in turn, is installable within a standard electrical switch box such as, for example, a single gang electrical box.

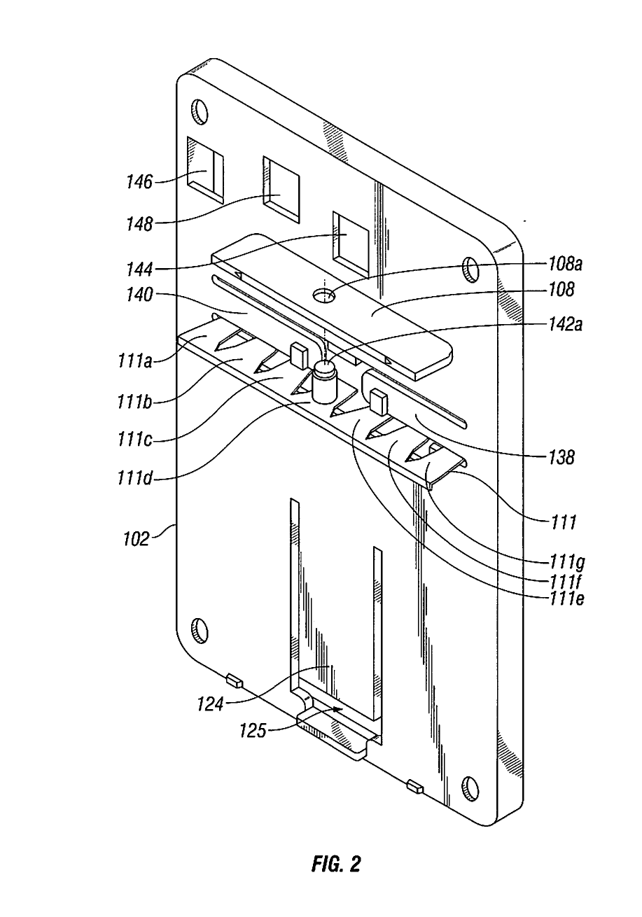

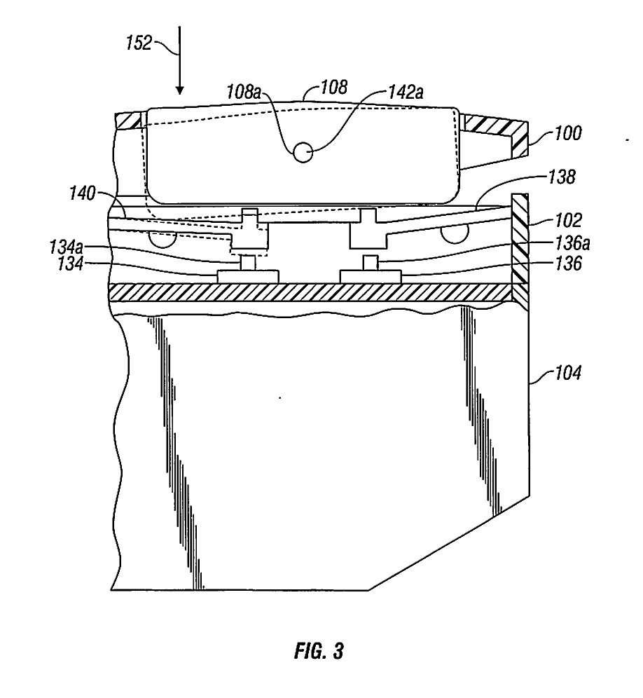

Referring now to FIGS. 2, 3, and 5, a perspective view of the housing cover 102 is depicted showing the so-called neutral orientation of the rocker switch 108. As shown in FIG. 3, the housing cover 102 includes leaf springs 138, 140 which are movable to electromechanically engage contacts 134a and 136a disposed in housing 104. The light pipe 111 may be formed as an integral part of the housing cover 102 and illuminates to facilitate user control of the rocker switch 108. As mentioned above, housing cover 102 also includes slots 144, 146 and 148 formed therein which are positioned to engage corresponding interfaces 110A 110B, 110C, respectively, in a snap-fit manner.

With continued reference to FIG. 2, the light pipe 111 extends outwardly from the surface of the housing cover 102 and includes a peg 142A configured and dimensioned to be received within a pivot aperture 108a defined through rocker switch 108 to support rocker switch 108 in a pivot-like manner. As shown in FIG. 3, the rocker switch 108 is mounted to move leaf springs 138 and 140 into contact with contacts 134a and 136a when rotated about peg 142A. Light pipe 111 has legs 111A, 111B, 111C, 111D, 111E, 111F, and 111G which are configured to stabilize the rocker switch 108 during rotation thereof.

FIG. 3 shows the interaction of rocker switch 108 with leaf springs 138 and 140 (shown in phantom representation). Each contact 134a and 136a is operably connected to a corresponding micro-switch 134 and 136 respectively. The contacts 134a and 136a may be spring-loaded to enhance tactile feel of the rocker switch 108 through a range of motion. In other words, when rocker switch 108 is depressed to pivot, the leaf spring, e.g., 138, engages contact 136a which, in turn, pushes down to activate micro switch 136. Upon release of rocker switch 108, leaf spring 138 recoils back to a neutral or original position allowing contact 136a of micro switch 136 to spring back into position. Pivoting rocker switch 108 in the opposite direction, causes a similar effect on micro switch 134.

Light pipe 111, peg 142A, leaf springs 138 and 140, and micro-switches 136 and 134 together form a rocker switch assembly that, when activated, may be used to control the intensity of a light, the relevant speed of a fan, the temperature setting of a thermostat, or any other similar electrical device and/or system connected to the switch of the present disclosure. In embodiments, light pipe 111, peg 142A, leaf springs 138 and 140, and micro-switches 136 and 134 together form a rocker switch assembly that, when activated, may be used to actuate an ON/OFF switch.

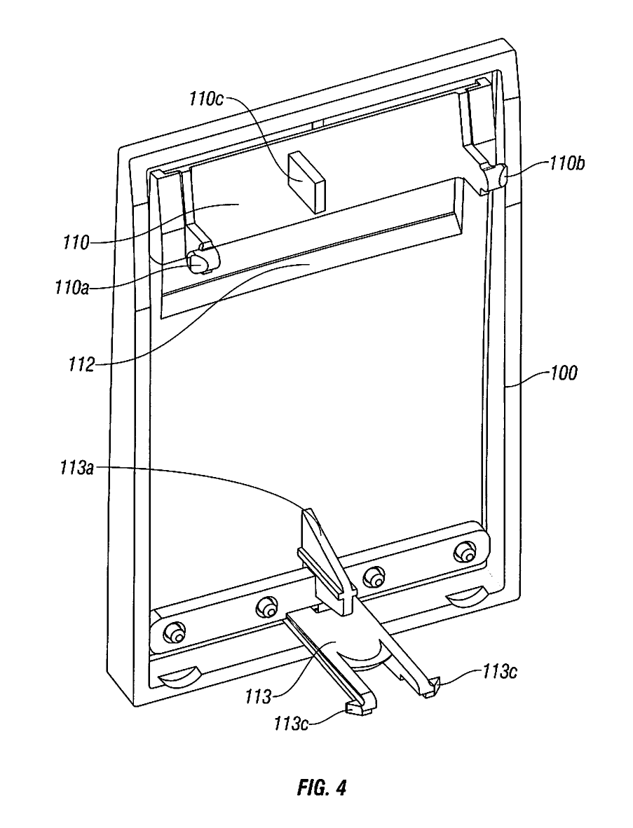

Referring now to FIG. 4, a rear perspective view of the paddle actuator 100 shown in FIG. 1 is depicted. Integrally formed on the rear of paddle actuator 100 is a power switch actuator tab 110. It should be understood that the power switch (not explicitly shown) can be implemented with an air-gap switch actuating tab 110C and corresponding air gap switch interface 248 adapted to disconnect a power line from one side of a switch or other device when oriented in an open orientation. It will be readily understood that the power switch can be implemented with other types of switches and is not limited to an air-gap switch. Formed on actuator tab 110 are mechanical interfaces 110A, 110B, and 110C. Also formed on paddle actuator 100 is a switch actuating tab 113A and a paddle locking tab 113. As mentioned above, paddle locking tab 113 includes mechanical interfaces 113C which operatively lock the paddle actuator 100 to housing cover 102.

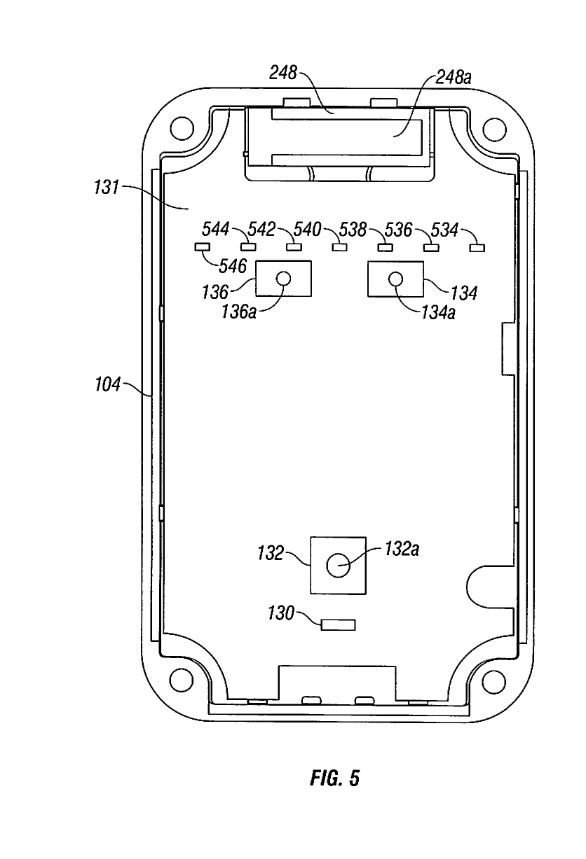

Referring now to FIG. 5, depicted therein is a printed circuit board 131. Certain elements of printed circuit board 131 are positioned to engage corresponding elements of the paddle actuator 100 of FIG. 1 and housing cover 102 of FIG. 2. That is, when switch 10 is assembled, housing cover 102 is sandwiched between paddle actuator 100 and printed circuit board 131. Paddle actuator 100, housing cover 102, and circuit board 131 are operatively coupled to each other to form a sub assembly within housing 104 to complete the switching device 10 of FIG. 1. As shown in FIG. 5, printed circuit board 131 includes a micro switch 132 having a spring-loaded plunger 132A. In embodiments, the power switch (not explicitly shown) may be implemented with an air-gap switch actuating tab. In embodiments, air-gap switch may be mounted on another printed circuit board (not explicitly shown) located relative to printed circuit board 131 or may be integrally-associated with printed circuit board 131.

An air-gap switch interface 248 extends through a cut out in printed circuit board 131 as shown. Micro-switches 134 and 136 and their corresponding spring-loaded plungers 134A and 136A are also disposed on printed circuit board 131 and positioned to correspond to the placement of leaf springs 138 and 140 (FIG. 2), respectively. LEDs 534, 536, 538, 540, 542, 544 and 546 are positioned to correspond to the locations of the legs 111A-G of light pipe 111 (FIG. 2) such that when housing cover 102 and circuit board 131 are cooperatively assembled, each corresponding LED 534, 536, 538, 540, 542, 544 and 546 is positioned directly beneath a corresponding leg 111A-G of light pipe 111.

In use, when rocker switch 108 is depressed to pivot, any one or more of LEDs 534, 536, 538, 540, 542, 544, and 546 is configured to illuminate to provide a visual status of a load connected to the switching device 10. By way of example, a first depression of rocker switch 108 may illuminate LED 546 and a second depression of rocker switch 108 may illuminate LED 544 and turn off LED 546. Alternatively, the second depression of rocker switch 108 may illuminate LED 544 such that LEDs 546 and 544 are illuminated simultaneously and/or in sequence from left to right. In this scenario, each subsequent depression of rocker switch 108 illuminates the LED to the right (e.g., LED 542, LED 540, etc.) or the LED following the LED illuminated by the previous depression of rocker switch 108 (e.g., a third depression of rocker switch 108 illuminates LED 542). In embodiments, LEDs 534, 536, 538, 540, 542, 544, and 546 may illuminate individually or in sequence from right to left. For example, a first depression of rocker switch 108 may illuminate LED 534 and each subsequent depressions of rocker switch 108 illuminates the LED to the left (e.g., LED 536, LED 538, etc.) or the LED following the LED illuminated by the previous depression of rocker switch 108.

In embodiments, paddle actuator 100 may be configured to cause any one or more of LEDs 534, 536, 538, 540, 542, 544, and 546 to illuminate in the same manner as described above with respect to rocker switch 108 (e.g., individually, sequentially from right to left, sequentially left to right, or any other possible combination, etc.). The seven LED 534, 536, 538, 540, 542, 544, and 546 configuration (FIG. 5) and corresponding seven leg 111A-G configuration (FIG. 2) are illustrative only. That is, the switching device 10 may include any suitable number of LEDs and corresponding legs (e.g., 3, 5, 9, etc.) as would be necessary to effect the switching device 10 operating as intended and in accordance with the present disclosure.

With returned reference to FIG. 2, housing cover 102 has a slot or an opening 148 defined therethrough positioned such that actuator tab 110C of air-gap actuator 110 (FIG. 4) extends to engage air-gap switch interface 248 (FIG. 5) when housing cover 102 is mated with paddle actuator 100 and circuit board 131. If the air-gap switch is not closed by virtue of the paddle actuator 100 being physically incorporated atop housing cover 102, energy will not flow through the switching device electrical elements to operate the switching device 10.

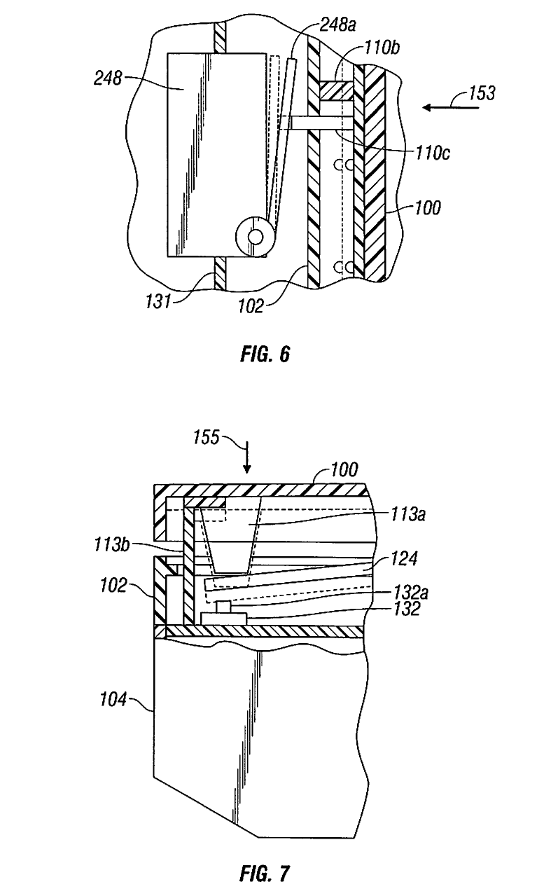

FIG. 6 shows the details of the air-gap switch actuating tab 110c and interface 248. As depicted, when paddle actuator 100, housing cover 102 and circuit board 131 are cooperatively assembled, pressing paddle actuator 100 in the direction indicated by directional arrow 153 extends air-gap switch actuating tab 110c of air-gap actuator 110 through opening 148 in housing cover 102 to engage spring-loaded lever 248A of air-gap switch 248. It should be understood that the operation of air-gap switch 248 can be the reverse of the above description. That is, when the paddle actuator 100 is depressed, air-gap switch 248 connects the power line (not explicitly shown) to the switch 10 and when paddle actuator 100 is pulled outward from the rest position to a pulled out position, the air-gap switch 248 disconnects the power line from the switch 10. Pulling paddle actuator 100 from the rest position to the pulled out position may be accomplished by pulling the bottom portion of paddle actuator 100 in the direction indicated by directional arrow 157 in FIG. 9 to pivot paddle actuator 100 about mechanical interfaces 110B and/or rotate paddle actuator 100 in the clock-wise direction from the rest position. Rotation of paddle actuator 100 in the clock-wise direction from the rest position to the pulled out position may also be achieved by depressing a top portion of paddle actuator 100 by applying sufficient force thereto. Optionally, a detent (not shown) may be provided such that when paddle actuator 100 is pulled and the air-gap switch 248 disconnects power to the switch 10, the paddle actuator 100 will remain in a pulled out position.

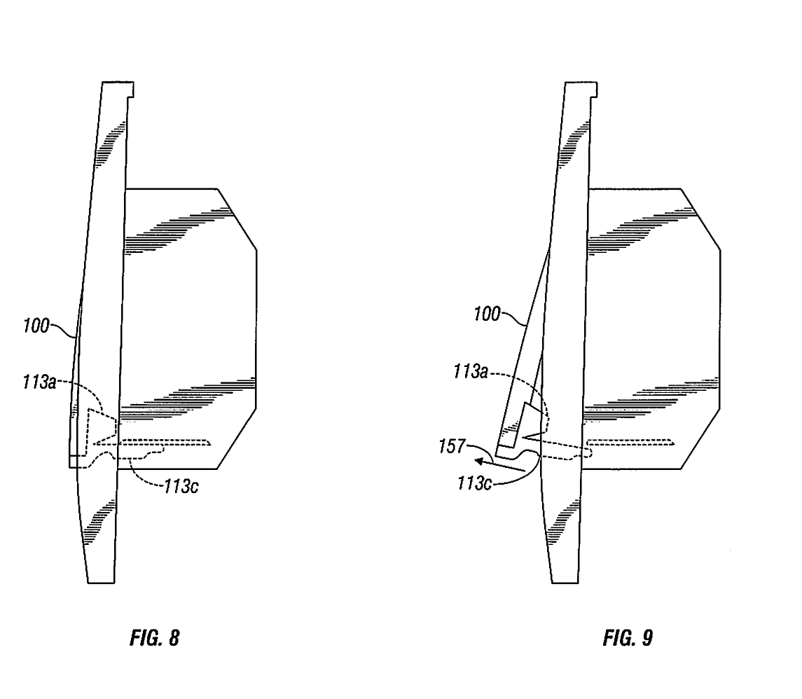

When paddle actuator 100, housing cover 102 and circuit board 131 are cooperatively assembled, paddle actuator 100 pivots along mechanical interfaces 110A, 110B which are snap-fit into wells 144 and 146, respectively. Located directly beneath the point of resilient contact between tab 113A and leaf spring 124 is micro-switch 132 and spring-loaded plunger 132A. This arrangement, depicted in FIG. 7, brings actuating tab 113A into resilient contact with a leaf spring 124 formed in housing cover 102 (see FIGS. 2, 4, and 7) to actuate the spring-loaded plunger 132A disposed in housing 104 which activates micro-switch 132 to connect the switching device 10 to line phase or electrical power or interrupt connection of the switching device 10 to line phase or electrical power. This action changes the state of a load connected to switch 10 from OFF to ON or vice-versa. In embodiments, this action may be configured to change the state of a load connected to switch 10 from DIM to BRIGHT and/or any one or more levels therebetween (e.g., greater than DIM and less than BRIGHT).

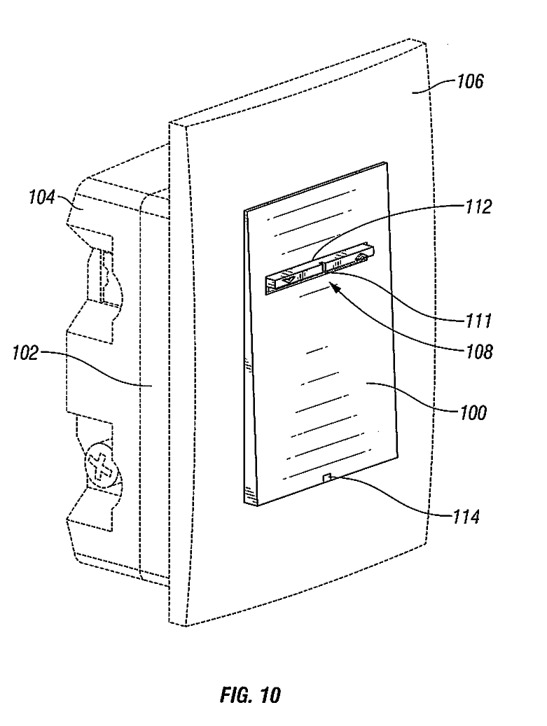

The sloping ramp configuration of locking surface 113C shown in FIGS. 8 and 9 permits retraction of tab 113 and locking surface 113C from opening 125 (FIG. 2) when sufficient force is applied to a bottom portion of paddle actuator 100, as shown in FIG. 9.

Still referring to FIG. 9, when the bottom portion of paddle actuator 100 is pulled in the direction indicated by directional arrow 157, surface 113C disengages from tab 124 and permits paddle actuator 100 to pivot about mechanical interfaces 110B and/or rotate in the clock-wise direction.

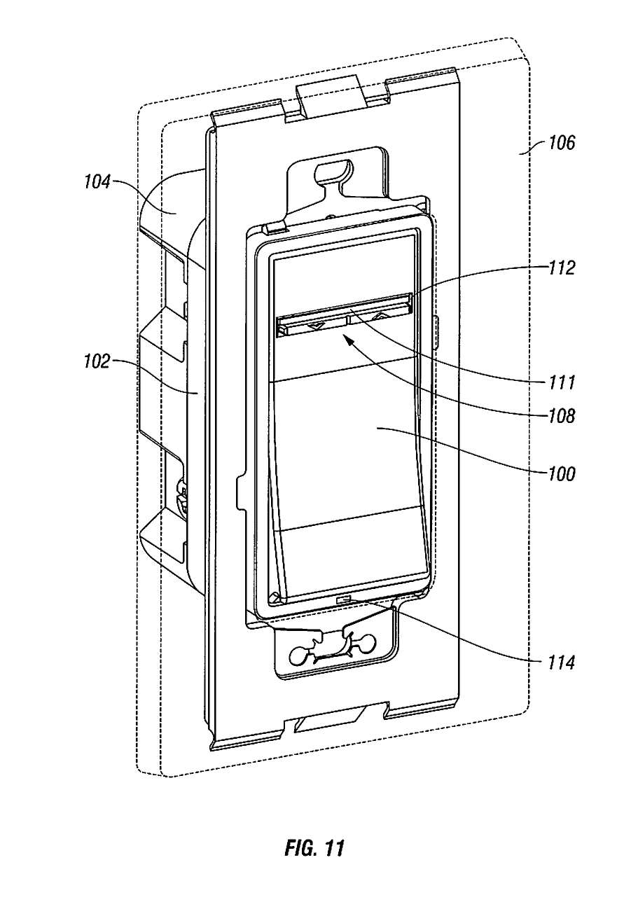

Referring now to FIG. 10, another embodiment of the present disclosure is shown depicting another dimmer switch. This dimmer switch includes a housing 104, a housing cover 102, and a paddle actuator 100. The paddle actuator 100 includes an opening or aperture 112 defined therethrough which is dimensioned to receive a light pipe 111 and a rocker switch 108 therein. In the illustrated embodiment, light pipe 111 is disposed below rocker switch 108.

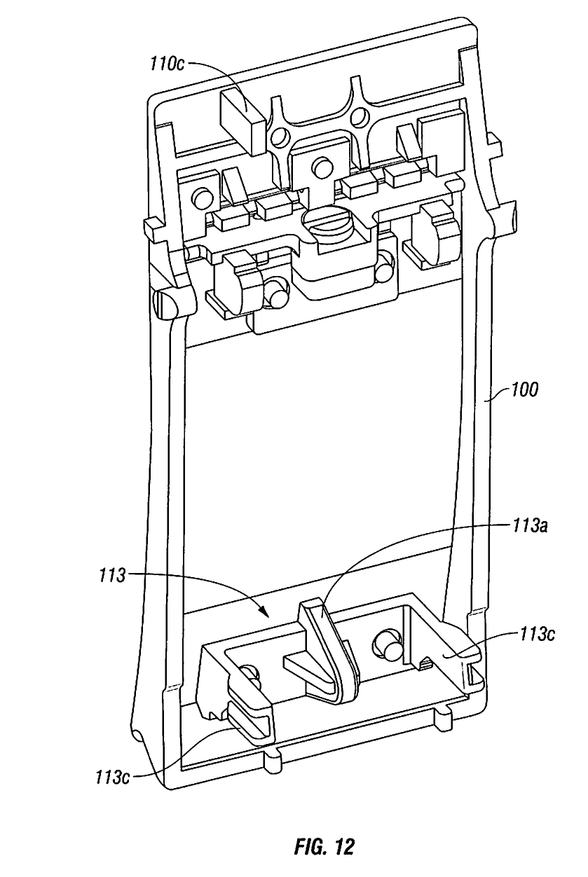

Referring now to FIG. 11, another embodiment of the present disclosure is shown depicting another dimmer switch This dimmer switch includes a housing 104, a housing cover 102, and a paddle actuator 100. The paddle actuator 100 includes an opening or aperture 112 defined therethrough which is dimensioned to receive a light pipe 111 and a rocker switch 108 therein. A rear perspective view of the paddle actuator 100 shown in FIG. 11 is depicted in FIG. 12.

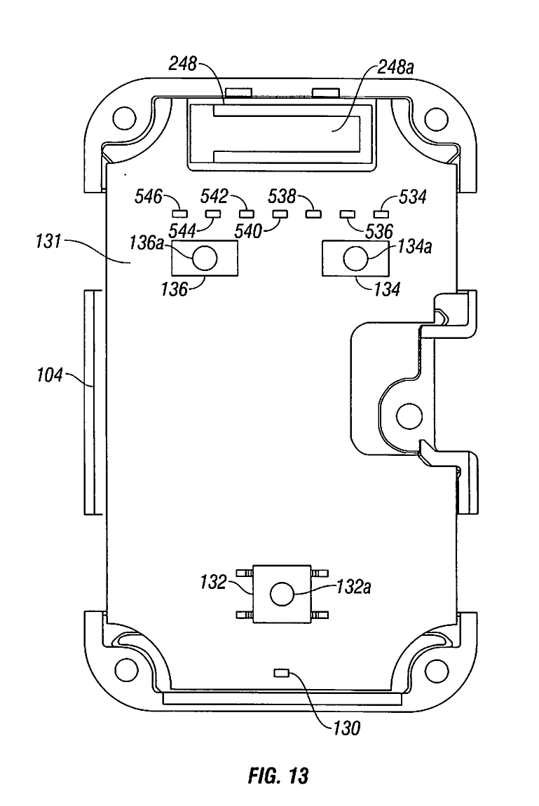

Referring now to FIG. 13, depicted therein is a printed a circuit board 131 having certain elements positioned to engage corresponding elements of the paddle actuator 100 and housing cover 102 of FIG. 11.

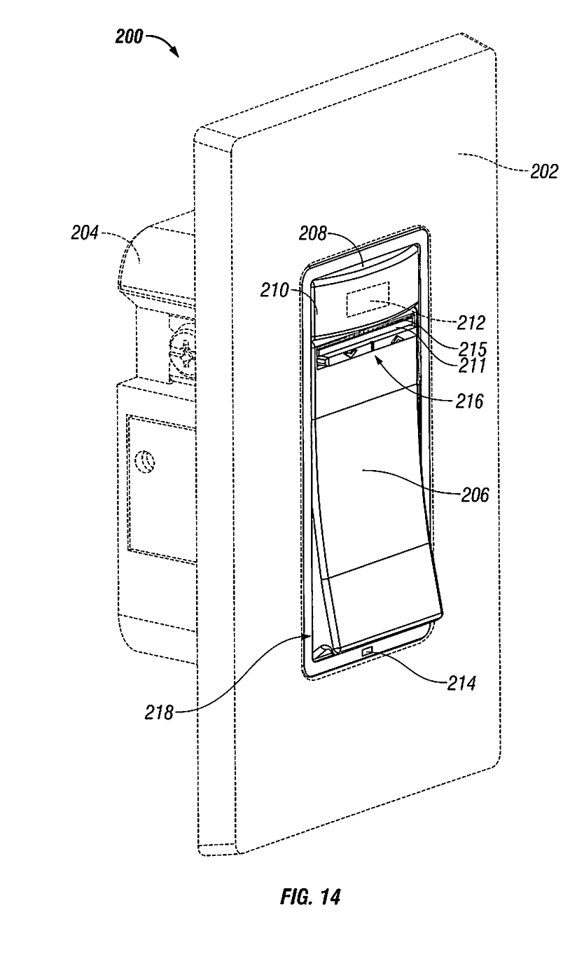

Referring now to FIG. 14, a switching device 200 according to another embodiment of the present disclosure is shown. Switching device 200 is substantially as described above with respect to switching device 10 and will only be described to the extent necessary to describe the differences between the embodiments. Switching device 200 generally includes a housing 204, a wallplate or faceplate 202 mountable to a front face of housing 204, a light 214, and a paddle actuator 206. Paddle actuator 206 includes an opening or aperture 215 defined therethrough which is dimensioned to receive a light pipe 211 and a rocker switch 216 therein. In some embodiments, the light pipe 211 and the rocker switch 216 may be omitted from switching device 200. In this scenario, the switching device 200 may operate as a simple “On/Off” switch.

In the embodiment shown, switching device further includes a sub-housing 208 including an aperture (not shown) disposed on the front face of housing 204. The aperture is shown in the illustrated embodiment at least partially covered by a lens or window 210. In other embodiments, the lens or window 210 may be omitted. The sub-housing 208 is configured to house any one or more suitable components configured to operate in cooperation with switching device 200. In the illustrated embodiment of FIG. 14, for example, sub-housing 208 houses a sensor 212 (shown in phantom) therein that electrically connects to circuit board 131 (see FIGS. 5 and 13). Sensor 212 may be, for example without limitation, an occupancy sensor, a passive infrared sensor (PIR), an ultrasonic sensor, an audio sensor, an IR repeater, a humidity sensor, a temperature sensor, a heat sensor, a barometric sensor, a photocell configured to sense ambient light, a charge-coupled device (CCD), an image sensor, a camera, or any combination thereof. In embodiments wherein sensor 212 is embodied as an image sensor, a camera, and/or a CCD, any one of these components may serve any suitable function, for example, occupancy sensing. As illustrated in FIG. 14, wallplate 202 surrounds paddle actuator 206 and sub-housing 208 and/or sensor 212 upon mounting of wallplate 202 to housing 204. More specifically, wallplate 202 defines an aperture 218 that surrounds paddle actuator 206 and sub-housing 208. As shown in the illustrated embodiment, paddle actuator 206 occupies an area of aperture 218 and/or the front face of housing 204 that is greater than a remaining area of aperture 218 and/or the front face of housing 204, which is substantially occupied by sub-housing 208 and/or sensor 212. In this scenario, the area of aperture 218 and/or the front face of housing 204 occupied by paddle actuator 206 is greater than 50% of the total area of aperture 218 and/or the front face of housing 204 and the remaining area of aperture 218 and/or the front face of housing 204, which is substantially occupied by sub-housing 208 and/or sensor 212, is less than 50%. In certain embodiments, the above scenario may be reversed, i.e., sub-housing 208 and/or sensor 212 occupies greater than 50% of the total area and paddle actuator 206 substantially occupies the remaining area of aperture 218 and/or the front face of housing 204, which is less than 50% of the total area. In other embodiments, the area occupied by paddle actuator 206 and the area occupied by sub-housing 208 and/or sensor 212 may be substantially the same.

More specifically, in one embodiment, the respective percentages of total area of aperture 218 and/or the front face of housing 204 occupied by paddle actuator 206 and sub-housing 208 (and/or sensor 212), respectively, is about 60% and about 40%, respectively. In another embodiment, the respective percentages of total area of aperture 218 and/or the front face of housing 204 occupied by paddle actuator 206 and sub-housing 208 (and/or sensor 212), is about 70% and about 30%, respectively.

In certain embodiments, any one or more control elements may be included to limit the range, sensitivity, and/or response of the sensor based on the requirements of the user. An example of such an clement is a so-called “blinder” that is used to adjust or limit the field of view of sensor 212. An example of a blinder is disclosed in U.S. Pat. No. 5,739,753, the entirety of which is incorporated herein by reference. In addition to or in lieu of sensor 212, sub-housing 208 may house any one or more other suitable components configured for use with switching device 200 such as, for example, an illumination device (e.g., a guide light, a night light, etc.), a timer mechanism, one or more indicators (e.g., LED) configured to generate visual and/or audible feedback to a user and/or provide a visual/audible status of switching device 200. In embodiments wherein a timer mechanism is included, the timer mechanism may be configured to automatically control the state of a load (e.g., a light fixture) connected to switching device 200. Control of the state of a load connected to switching device 200 may include, but is not limited to, changing the state of the load between DIM and BRIGHT (in the scenario of a light fixture) and between ON AND OFF at specific time intervals as dictated by user-controlled timer mechanism settings. Further, the timer mechanism is not limited to controlling a load connected directly to the switching device 200. That is, the timer mechanism may be configured to control the state of any suitable load remote from switching device 200 through any suitable wireless communication protocol (e.g., Bluetooth, WiFi, Z-Wave, IEEE 802.11, etc.).

In embodiments, switching device 200 may include suitable mechanical components (not shown) operably coupled to the sensor 212 such that sensor 212 is movable relative to housing to enable the field-of-view of sensor 212 to be adjusted and/or aimed as desired. In the illustrated embodiment of FIG. 14, window 212 is shown as being bowed or arc-like in shape such that window 212 protrudes relative to an outer surface of faceplate 202. In other embodiments not explicitly shown, window 212 may be flat such that window 212 is substantially co-planar with the outer surface of faceplate 202. Alternatively, the window 212 may be of any suitable shape or the window may be omitted.

Suitable circuitry from the sensor element 212 is electrically connected to the circuit board 131 such that operation (e.g., dimming, ON, OFF, etc.) of switching device 200 may be controlled based on sensed information received, as input, at the circuit board 131 from the sensor 212. By way of example, sensor 212 may be configured to sense a condition such as motion and/or occupancy in the field-of-view of sensor 212 and/or window 210. Based on this sensed information, the sensor 212 generates a feedback signal to the circuit board 131 to cause switching device 200 to change the state of a load connected thereto and/or cause one or more indicators housed within aperture 208 to provide visual and/or audible feedback. More specifically, based on signals received, as input, at the circuit board 131 from the sensor 212, the switching device 200 may be configured to change the state of a load (e.g., light fixture) connected to the switching device 200 from ON to OFF, from OFF to ON, from DIM to BRIGHT, from BRIGHT to DIM, and/or any one or more levels therebetween (e.g., greater than DIM and less than BRIGHT).

It should be understood that the embodiment of FIG. 14 is illustrative only. That is, sub-housing 208 and/or sensor 212 may be implemented substantially as described above with respect to switching device 200 in any of the switching device embodiments illustrated in FIGS. 1-13. Alternately, the sub-housing may be omitted without departing from the spirit of this disclosure.

While several embodiments of the disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A switching device, comprising:
a housing adapted to be mounted within a single gang electrical box;
a paddle actuator operably coupled to a front face of the housing and adapted to control a state of a load, the paddle actuator having a pair of opposing long sides and a pair of opposing short sides, wherein the paddle actuator is biased to a neutral position and configured to pivot relative to the front face of the housing about a hinge disposed proximate to one of the short sides of the paddle actuator;
at least one component operably coupled to the housing and disposed adjacent to the short side of the paddle actuator disposed proximate to the hinge, the at least one component configured to sense at least one condition and cause the switching device to control the state of the load based on the at least one sensed condition;
a control element operably coupled to the at least one component and configured to control at least one of a sensing range and a sensitivity of the at least one component, wherein the paddle actuator occupies at least 50% of the front face of the housing and the at least one component substantially occupies a remainder of the front face.

2. A switching device according to claim 1, wherein the paddle actuator is configured to pivot relative to the housing to actuate an air-gap switch disposed within the housing between an open configuration and a closed configuration.

3. A switching device according to claim 2, wherein the paddle actuator is pivotable relative to the housing between a depressed condition to close the air-gap switch and a pulled-out position to open the air-gap switch.

4. A switching device according to claim 2, wherein the paddle actuator is pivotable relative to the housing between a depressed condition to open the air-gap switch and a pulled-out position to close the air-gap switch.

5. A switching device according to claim 1, further comprising a rocker actuator disposed at least partially within an aperture at least partially defined by the paddle actuator, the rocker actuator being configured to pivot relative to the aperture to engage at least one switch disposed within the housing, the at least one switch configured to change the state of the load upon engagement by the rocker actuator.

6. A switching device according to claim 1, wherein the at least one component is housed within a sub-housing operably coupled to the housing.

7. A switching device according to claim 6, wherein the sub-housing is at least partially covered by a window.

8. A switching device according to claim 1, wherein the paddle actuator has a pair of opposing long sides and a pair of opposing short sides, the at least one component being disposed adjacent to one of the short sides of the paddle actuator.

9. A switching device according to claim 1, wherein the at least one sensed condition is selected from the group consisting of motion, occupancy, humidity, infrared light, ambient light, heat, barometric pressure, ultrasonic conditions, sound, imagery, and temperature.

10. A switching device according to claim 1, wherein the control element is configured to be adjusted to limit at least one of the range and the sensitivity of the at least one component.

11. A switching device according to claim 1, wherein the control element is a blinder configured to block access to at least a portion of a field of view of the at least one component.

12. A switching device according to claim 1, wherein the at least one component further comprises an illumination device configured to indicate at least one of a status of the switching device and the state of the load.

13. A switching device according to claim 1, wherein the state of the load is one of an ON/OFF state and a DIM/BRIGHT/INTENSITY state.

14. A switching device according to claim 1, wherein the state of the load is variable between a DIM state and BRIGHT state.

15. A switching device, comprising:
a paddle actuator adapted to control a first state of a load and having a pair of opposing long sides and a pair of opposing short sides, the paddle actuator being operably coupled to a housing adapted to be mounted within a single gang electrical box;
a rocker actuator operably coupled to the housing and disposed at least partially within an aperture at least partially defined by the paddle actuator, the rocker actuator configured to control a second state of the load;
at least one component operably coupled to the housing and disposed adjacent to the paddle actuator, the at least one component configured to sense at least one condition and to cause the switching device to control at least one of the first and second states of the load based on the at least one sensed condition; and
a wallplate mountable to the housing and defining an aperture that surrounds the paddle actuator and the at least one component when the wallplate is mounted to the housing such that the paddle actuator and the at least one component are exposed relative to the wallplate.

16. A switching device according to claim 15, wherein the first state of the load is one of an ON and OFF state and the second state of the load is variable between a DIM and BRIGHT state.

17. A switching device according to claim 15, wherein the first state of the load is variable between a DIM and BRIGHT state and the second state of the load is one of an ON and OFF state.

18. A switching device according to claim 15, wherein the at least one component is disposed adjacent to one of the short sides of the paddle actuator.

19. A switching device, comprising:
a paddle actuator adapted to control a first state of a load and having a pair of opposing long sides and a pair of opposing short sides, the paddle actuator being operably coupled to a housing adapted to be mounted within a single gang electrical box;
a rocker actuator operably coupled to the housing and disposed at least partially within an aperture defined at least partially by the paddle actuator, the rocker actuator configured to control a second state of the load; and
at least one sensor operably coupled to the housing and disposed adjacent to the paddle actuator, the at least one sensor configured to sense at least one condition, wherein the at least one sensed condition is selected from the group consisting of motion, occupancy, humidity, infrared light, ambient light, heat, barometric pressure, ultrasonic conditions, sound, imagery, and temperature, the at least one sensor being configured to cause the switching device to control at least one of the first and second states of the load based on the at least one sensed condition.

20. A switching device according to claim 19, wherein the at least one sensor is disposed within a sub-housing, the sub-housing being disposed adjacent to one of the short sides of the paddle actuator and being at least partially covered by a window.
